(19) United States
(12) Patent Application Publication
(10) Pub. No.: US 2016/0225071 A1
(43) Pub. Date: Aug. 4, 2016

(54) INTERACTIVE CUSTOMER ASSISTANCE DEVICES AND METHODS

(71) Applicant: NCR Corporation, Duluth, GA (US)

(72) Inventors: Ashley Breen, Dundee (GB); Craig Garrigan, Dundee (GB)

(21) Appl. No.: 14/610,380

(22) Filed: Jan. 30, 2015

(51) Int. Cl. G06Q 40/02; G06Q 20/10; G06Q 20/18; G06Q 20/40

(52) U.S. Cl. CPC G06Q 40/02; G06Q 20/405; G06Q 20/1085; G06Q 20/18

(57) ABSTRACT

Various embodiments herein each include at least one of systems, devices, methods, and software for interactive customer assistance devices and methods. One embodiment in the form of a method includes presenting, on a first device, data with regard to a transaction session initiated on a second device, the first device collaborating in performance of the transaction session via a network. The method further includes transmitting a request for a third device to collaboratively join the transaction session in response to command input received by either the first or the second device. The third device in such embodiments is capable of presenting sensitive data not allowed for viewing by a user of the second device and not capable of presentation on the first device, such as by an app deployed on the second device.

### BACKGROUND INFORMATION

Some more modern banking outlets, such as bank branches, and retail outlets, such as stores, provide their personnel (e.g., tellers, clerks, supervisors, etc.) with a tablet device that runs an application allowing them to assist customers with a variety of transactions. An example of such a system is the NCR Interactive Banker product available from NCR Corporation of Duluth, Ga. Such systems generally join teller and tablet terminals, customer terminals (e.g., Automated Teller Machine “ATM”, Self Service Terminal “SST”), and bank branch and core banking systems to provide interactive customer service capabilities and experiences. However, to obtain assistance, customers still often need to seek out or wait for an employee with a tablet or an open employee station to obtain assistance. Further, there may be a limited number of employees with tablets, especially during peak times such as at lunchtime within an urban bank branch.

In addition, transactions customers are performing may require supervisor approval, such as for large bank withdrawals or product returns, or assistance of an employee having a certain role or skill to assist with a complex transaction, such as submitting a mortgage application or picking up a prescription that requires counseling from a pharmacist. Availability of such personnel is typically limited.

Further, the tablets or other mobile device of a teller may not be physically in their possession at all times and the tablet or other mobile device may include data that is sensitive and should be protected from one or both of the customer and others in the bank branch.

### SUMMARY

Various embodiments herein each include at least one of systems, devices, methods, and software for interactive customer assistance devices and methods.

One embodiment in the form of a method includes presenting, on a first device, data with regard to a transaction session initiated on a second device, the first device collaborating in performance of the transaction session via a network. The method further includes transmitting a request for a third device to collaboratively join the transaction session in response to command input received by either the first or the second device. The third device in such embodiments is capable of presenting sensitive data not allowed for viewing by a user of the second device and not capable of presentation on the first device, such as by an app deployed on the second device.

Another method embodiment includes presenting, on a first device, data with regard to a transaction session initiated on a second device, the first device collaborating in performance of the transaction session via a network. This method embodiment also includes receiving input on the first device to present sensitive data, the sensitive data to be presented via an ancillary output device other than a primary output device of the first device. This method embodiment further includes presenting the sensitive data via the ancillary output device of the first device.

A further embodiment is in the form of a computing device. The computer device of such embodiments includes at least one network interface device, at least one processor, and at least one memory device, the at least one memory device storing instructions executable by the at least one processor. The instructions are executable by the at least one processor to connect a first device and second device in a joint transaction session associated with a transaction initiated on the second device. Within the joint transaction session, the instructions are executable to receive, from the first device via the at least one network interface device, a request for a third device to join the joint transaction session, the third device being a wearable computing device including a display. The instructions are further executable to connect the third device to the joint transaction session in response to a received acceptance of an invitation to connect transmitted via the at least one network interface device.

These and other embodiments are presented herein.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, devices, methods, and software for interactive customer assistance devices and methods. Such embodiments are provided in the context of interactive terminal services that connect SST users to customer assistance personnel within SST transactions. While a common context in which interactive terminal services are provided is within an ATM transaction session, terminal services may be provided in other contexts in some embodiments. For example, in the contexts of SST checkout stations, customer assistance kiosks, restaurant table terminals, and the like.

Interactive terminal services, in some embodiments, allow personnel to monitor activities of terminal users and to connect in interactive sessions with terminal users such as through audio, video, or audio and video communication sessions. Interactive terminal services also allow personnel to participate in transactions such as by providing approval of certain types of transactions, provide terminal operation guidance to users, to answer questions with regard to transaction options provided on the terminal, among other activities.

Terminal services can be implemented to help customers to accept self-service options provided to them through terminals by making assistance readily, and quickly, available instead of waiting in line, such as for a teller window at a bank branch. In addition, many people prefer to handle transactions with a person. Interactive terminal services provide these people the benefits of speed of automation while also providing a readily available opportunity to interact according to their preference. Regardless of the particular transaction type, it is common that there is sensitive data that is to be viewable by customer service personal or maybe even only select customer service personnel, but not by the customer and others that may be present in a facility. Various embodiments herein provide solutions to limit access to such data and to present such sensitive data in different manners to protect the sensitive nature of the data. This may include limiting devices on which the data may be presented, presenting data via audio or video output devices to only select personnel on select devices or via certain video and audio output devices. These certain video and audio output devices, in some embodiments may include one or more products such as the GOOGLE® GLASS product available from GOOGLE, INC. of Mountain View, Calif., the OCULUS RIFT product available from OCULUS VR, L.L.C. of Menlo Park, Calif., and wired and wireless video and audio output devices that may be mobile computing devices themselves or coupled to other mobile computing devices such as tablets and smartphones.

In a typical interactive terminal services deployment at a retail outlet, such as a store or a bank branch, terminals, computing devices of personnel, and core systems of the retail outlet are joined by a terminal services server. Customers interact with a terminal, such as an SST checkout station or ATM. Personnel monitor customer terminal activity on their own device, such as mobile computing device (e.g., tablet, smartphone), a personnel station (i.e., checkout station, computer at a bank teller window or customer service desk), or wearable computing device. At any time during the transaction, the customer may select an option on the terminal to request customer assistance or customer assistance may be automatically requested based on a transaction requirement, failure, or after an idle period. A member of the personnel team, such as a bank teller, may then visit the terminal to assist the customer in person. The bank teller may then participate in the transaction either through the terminal or via their own computing device. In other situations, the bank teller may join and participate in the transaction via their computing device away from the terminal. In such situations, the bank teller or other customer assistance personnel may be able to view sensitive data of or associated with the customer that the customer or others are not to see, such as credit history information, credit risk information, customer relationship history data, offers to be provided orally to the customer, and the like. This sensitive data may be presented on the bank teller or customer service personnel device in a manner or via an output mechanism such that it is not viewable by the customer or others.

However, in some instances, the teller who has joined the transaction to provide assistance may be unable to complete the transaction with the customer—such as in instances when the teller lacks the expertise or authorization to resolve the customer's problem or to access data needed to provide requested assistance or because the teller needs to leave for some other reason such as a high priority phone call, comfort break, end of their working day, and the like. In such situations, the teller would prefer not to lose any decisions they have already made on behalf of the customer, for example, in approving some but not all checks of a multi-check deposit transaction. To allow the teller to depart the transaction without losing any effort already expended, the interactive terminal solution may allow the teller to pass the transaction to another teller in the branch or at a remote location without losing any of the completed transaction decisions. In embodiments where the teller is assisting via the terminal, the transaction handoff may be initiated via a terminal user interface. In embodiments where the teller is assisting via their own computing device, the handoff may be initiated via the computing device.

The handoff to another teller or person having sufficient authority or expertise, such as a supervisor, is made in some embodiments from a presented pick-list that shows other logged on tellers and supervisors and allows the current teller to delegate the remainder of the assistance session to a selected teller or supervisor.

The tablet or other output device indication (graphical and/or associated audio alert) for one teller requesting hand-over to another is different in some embodiments from the alert generated by a customer assistance request to allow the receiving teller to differentiate the two. Additionally, the new teller may be shown the identity of the teller who is requesting their help or delegating the remainder of the assistance request to them.

Similarly, some embodiments may allow the teller to select another to join the transaction as a third participant, such as to provide authorization for a banking transaction of a high value or to authorize a transaction reversal. This second teller may have access to sensitive information the first teller does not.

In either situation where a transaction is handed off or another joins the transaction, the new participant in the transaction is typically provided options to view previous activity within the transaction and other information related thereto, such as information with regard to the customer and one or more of their accounts.

These and other embodiments that allow multiple local or remote personnel to become involved in servicing assistance requests and to facilitate handoff of assistance requests between personnel are described herein with reference to the figures. Other embodiments are also described such as where sensitive information is limited for presentation to only certain personnel and only via certain output mechanisms.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

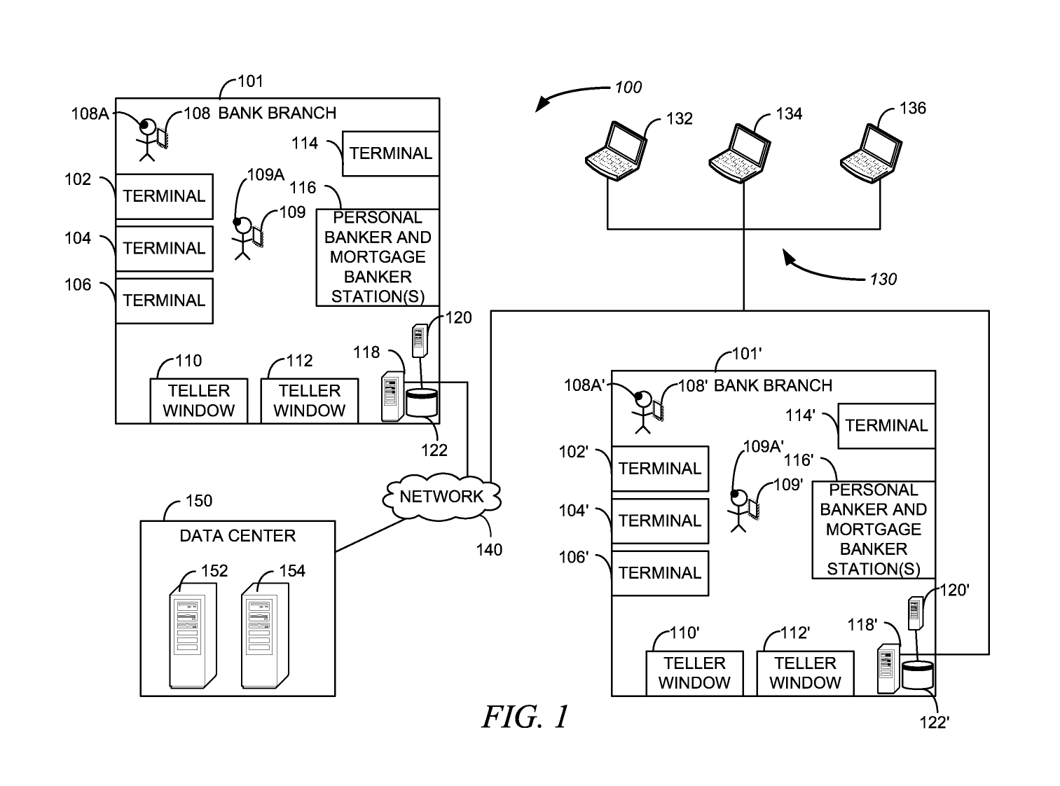

FIG. 1 is a logical block diagram of a system 100, according to an example embodiment. The system 100 is illustrated and described in a banking context, and more specifically a bank branch context. However, this is for illustration purposes only and is not intended to limit the extent of the disclosure herein as the contributions herein are equally applicable to other contexts, such as other retail contexts and restaurant contexts, among other contexts within which customers or other terminal users may be provided assistance in conducting terminal transactions.

The system 100, as illustrated, is deployed across a plurality of facilities that may be separated by short or long distances. The facilities include two bank branches 101, 101′, although there may be many bank branches. The facilities also include one or more data centers 150 where one or more core banking systems 152 may reside and one or more customer assistance centers 130 where remote customer service personnel may provide customer assistance via phone calls, video communication sessions, and interactive terminal services. Customer assistance center 130 personnel may utilize computing devices 132, 134, 136, such as one or both of personal computers and mobile devices, to interact with terminal 102, 104, 106, 114 users. The bank branches 101, 101′, one or more data centers 150, and one or more customer assistance centers 130 are connected by at least one network 140, such as the Internet, a leased network, and other networks.

As illustrated, the two bank branches 101, 101′ are intended to be identical for purposes of brevity and simplicity in description by avoiding superfluous details that do not assist in understanding the subject matter herein and the subjoined claims. Further, as one would readily appreciate that although there may be differences in bank branch sizes, numbers of deployed terminals and teller windows, and numbers of employees, the elements of bank branches, at least of the same banking enterprise, are quite similar. Thus, the description of bank branch 101 is also provided as the description for bank branch 101′. Any important distinctions between the two bank branches 101, 101′ are expressly described.

The bank branch 101 includes a number of terminals 102, 104, 106, 114, a number of teller windows 110, 112, and a number of personal banker and mortgage banker stations 116. The numbers of terminals 102, 104, 106, 114, teller windows 110, 112, and personal banker and mortgage banker stations 116 may vary between banks branches 101, 101′.

The bank branch also includes a number of mobile devices, such as tablets 108, 109, that may be provided to bank personnel, such as tellers, supervisors, and dedicated customer assistance personnel. In some embodiments, one or more of the bank personnel may also or alternatively be provided wearable mobile devices 108A, 109A that include one or both of heads-up displays, concealable displays, and audio output devices, such as a wired or wireless headset. In some embodiments, the wearable mobile devices 108A, 109A may simply be wearable output devices, such as heads-up displays and audio headsets that connect, wired or wirelessly, to a tablet 108, 109. The tablets 108, 109 and wearable mobile devices 108A, 109A wirelessly connect to a network of the bank branch 101 that may also connect to the network 140. Each of the teller windows 110, 112 and the personal banker and mortgage banker stations 116 typically include a computing device connected to the bank branch network.

The bank branch 101 may also include data processing resources, such as a local assistance server 118, a bank branch system 120, a database 122, and other data processing systems and devices. The local assistance server 118 is a set of processes that execute thereon to provide interactive terminal services on the terminals 102, 104, 106, 114, as will be discussed further below. The bank branch system operates to provide banking data processing services at the bank branch 101 and may maintain local copies or caches of select data from the core banking system 152 or bank branch data from the transactions conducting during a day that is uploaded to the core banking system 152 on a periodic basis. However, some bank branches may not include one or both of the local assistance server 118 and bank branch system 120 and instead access services via the network 140 of the core banking system 152 and an interactive services server 154 that may be deployed in the one or more data centers 150. In some other embodiments, the local assistance server 118 and bank branch system 120, although both being deployed to service the bank branch 101, may be individually deployed to locations remote to the bank branch 101 such as in the data center 150 or elsewhere and need not be co-located with one another. Regardless of where the local assistance server 118, bank branch system 120, and the core banking system 152 are located, each of which may be deployed singularly or in a distributed manner, each of these systems 118, 120, 152, which may also include the interactive services server 154, may be deployed individually in the same location or different locations.

In some embodiments, providing interactive terminal services relies on three elements. These elements are:
1. An Interactive terminal services application deployed to each terminal 102, 104, 106, 114;
2. Staff consoles which may be the tablets 108, 109, wearable mobile devices 108A, 109A, or computers deployed at teller windows and personal banker and mortgage banker stations; and
3. The local assistance server 118.

First, running on the each of the terminals 102, 104, 106, 114 as a part of terminal operating software or as an ancillary application or service, is the interactive terminal services application. The interactive terminal services may provide a set of services, used either directly or indirectly through other terminal software through service calls, to connect the respective terminal to one or more of a teller, customer assistance personnel, or customer assistance center 130 personnel.

Second, the staff console. The staff console is a device, such as the tablets 108, 109 and wearable mobile devices 108A, 109A that may execute a thin-client or thick-client staff console device app or application or access a browser-based application to participate in interactive terminal sessions and to monitor customer terminal activity.

The third element is the local assistance server 118, which can be a MICROSOFT® WINDOWS® server available from Microsoft Corporation of Redmond, Wash., a Linux-based server, or a server-class computing device having a different operating system. In some embodiments, a bulk of the terminal assistance software runs on this server. This is the orchestration point for other touch points. The local assistance server 118 joins the interactive terminal services application and the staff consoles to the bank branch and core banking systems 120, 152 or, in embodiments where the solution has not been integrated with the core banking systems 152, it may track transactions flowing through the bank branch network and provide a view of these on the staff consoles. Stated differently, the local assistance server 118 join teller and tablet terminals, customer terminals (e.g., Automated Teller Machine “ATM”, Self Service Terminal “SST”), and bank branch and core banking systems to provide interactive customer service capabilities and experiences.

In some embodiments, one or more of the interactive terminal services applications deployed to the terminals 102, 104, 106, staff consoles such as the tablets 108, 109, wearable mobile devices 108A, 109A, and computers and other computing devices of other bank personnel, the local assistance server 118, and the interactive services server 154 may include executable software or firmware components to facilitate one or both voice and video and voice communication between customers and bank personnel. For example, some embodiments may include components of or built upon an integrated collaboration services platform. Other embodiments may include or be built upon a real-time communication platform, such as the Web Real-Time Communications (WebRTC) platform.

In operation according to some embodiments, a customer may interact with one of the terminals 102, 104, 106, 114, such as to make a deposit to a bank account via an ATM terminal. For example, the customer may approach terminal 102, authenticate with an ATM card and PIN number, select a bank account, and enter details with regard to a deposit the customer desires to make. The customer may then tender items to be deposited to the ATM into an automated payment/deposit tendering device, such as by providing a check to be deposited to a check-reading device. The check-reading device images the check and the ATM, or a data processing system to which the ATM may connect, processes the check image and data read therefrom. The check processing may determine there is an issue with the check, such as that writing on the check cannot be read by the check processing system, that the check is likely to bounce, that a bank account of the check is fraudulent, or other issue. In such instances, the ATM may present the issue to the customer and the customer may request teller assistance by pressing a button on the ATM, such as a button presented on a touch screen. In some other embodiments, upon detection of the issue reading the check, the ATM or other process may automatically request assistance for the customer.

Either way that assistance is requested, the request may be presented within a user interface of each of the tablets 108, 109 and wearable mobile devices 108A, 109A in the bank branch 101. One of the tablet 108, 109 or wearable mobile device 108A, 109A users, such as a user of the wearable computing device 108A who is a teller, may accept the assistance request by selection of a control presented on the tablet by a wearable computing device 108A app or application accessed via a web browser of the wearable computing device 108A. This will begin a customer assistance session between the wearable computing device 108A and the ATM 102.

The teller may then visit the customer at the ATM 102 or remain in place and communicate with the customer within the customer assistance session via a voice (i.e., audio) or audio and video session established between the ATM 102 and the wearable computing device 108A. The teller may also access, via the wearable computing device 108A within the customer assistance session, data regarding the customer, the customer's account(s), and the transaction being attempted, including an image of the check from which the issue arose. Some such data may be sensitive data that is not viewable by the customer. This sensitive data will only be presented via an output device of the wearable computing device 108A that will not be viewable by the customer, such as via a heads-up display or audio headset of the wearable computing device 108A. The teller may resolve the issue with the check via the wearable computing device 108A. However, the teller may not have sufficient authority, knowledge to complete or time to complete approval, or access to sensitive customer data to complete the deposit.

In each of these situations, the teller may choose to transfer the customer assistance session to another bank employee having sufficient authority such as a user of the wearable computing device 109A within the bank branch who may be one or both of a supervisor with sufficient authority, access to sufficient sensitive data, and knowledgeable about the check approval process. The teller may instead choose to transfer the customer assistance session to a customer support specialist at a customer assistance center 130, such as a user of computing device 132, or an available teller or manager in another bank branch, such as bank branch 101′. In some embodiments, the choice of who will receive the customer assistance session is made by an automated process.

Regardless of who is chosen to receive the customer assistance session transfer, that user will be joined via their respective computing device (i.e., tablet 109, wearable computing device 109A, or computing device 132). The user will then be able to view data with regard to the customer, the customer's account(s), including sensitive data, and the transaction in progress, including a record of actions taken by both the customer and the teller via the wearable computing device 108A. In some embodiments, once the other bank employee successfully joins the customer assistance session, the teller is disconnected. However, in some instances, rather than leaving the customer assistance session, the teller remains and the other bank employee remains only for a period needed to resolve the issue, such as to approve the deposit.

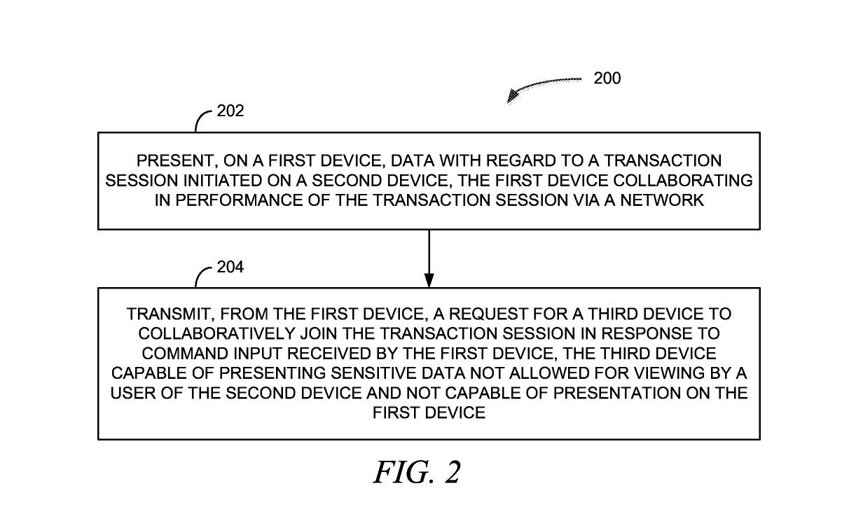

FIG. 2 is a block flow diagram of a method 200, according to an example embodiment. The method 200 is an example of a method that may be performed on an SST, such as an ATM, on a mobile device, such as a tablet or smartphone, or on another computing device, such as a personal computer. The method 200 is typically utilized by personnel of an entity that provides customer assistance via interactive terminal service, such as in a banking or retail environment.

In some embodiments, the method is performed in whole or in part by a thin or thick client app or application that executes on a mobile device, which may be or include one or more of a wearable computing device, a wearable video output device, and a wearable audio output device of a bank teller, checkout clerk, or other tasked with providing customer assistance to terminal users. The method 200 includes presenting 202, on a first device, data with regard to a transaction session initiated on a second device, the first device collaborating in performance of the transaction session via a network. The first device, in some embodiments, may be a mobile device, carried or worn, of such a person tasked with providing terminal users customer assistance. The second device, in some embodiments, may be a terminal, such as an ATM, SST, self-service checkout station, or other self-service terminal. The transaction-type of the method 200 may be dictated by a device-type of the second device. For example, when the second device is an ATM, the transaction of the method 200 is a banking transaction, such as a bank deposit or withdrawal, or a request to cash a check. Similarly, when the second device of a particular embodiment is a self-service checkout terminal, the transaction-type may be a product return, a purchase, a price check, a service order or request, and the like.

The method 200 further includes transmitting 204, from the first device, a request for a third device to collaboratively join the transaction session in response to command input received by the first device, the third device capable of presenting sensitive data not allowed for viewing by a user of the second device and not capable of presentation on the first device. The third device, in some embodiments, is a mobile device, carried or worn, of another person tasked with providing customer service located either in the same facility as the first device, in another facility such as another bank branch or store, in a customer assistance facility such as a facility common referred to as a call center, or elsewhere.

In some embodiments of the method 200, collaborating in performance of the transaction session by the first device includes transmitting data from the first device representative of input received on the first device with regard to a transaction activity initiated on the second device.

In some embodiments when the transaction session is a banking transaction session, data retrieved, presented, and exchanged between the devices is generally banking data. Banking data may include bank account data and data representative of banking transactions. Some such data may be sensitive data, such as data a bank or retail outlet maintains or obtains with regard to a customer. Such data may be viewable only be certain personnel or via certain output devices, such as by a user of the third computing device or via a worn, heads-up display or audio output device coupled to the third computing device.

In some embodiments of the method 200, the data exchanged in a transaction session includes data representative of or associated with attempt by a holder of a bank account on the second device to perform a banking transaction that has been denied on the second device. Regardless of the reason for denial, transaction denials may be overridden or simply subject to approval by a supervisor. When the user of the first device is not a supervisor, a third device of a supervisor may be joined to the transaction session or the transaction session may be transferred, or “handed off”, to the third device of the supervisor. When the third device is added to the transaction session, the third device gains access to the data with regard to the transaction session including data representative of actions previously performed during the transaction session and data identifying who performed each action. The third device may also have access to and present data with regard to customer credit history, banking history, overdrawn bank account balances, and other sensitive information. This data or a generalized indicator thereof may be sensitive data that is only viewable by supervisor personnel via authorized supervisor computing devices, such as a third device.

In some embodiments of the method 200, when the third device is added, the supervisor may perform the needed task, such as providing a needed approval, and the third device may then be disconnected. However in other embodiments, or under different circumstances, subsequent to the third device being successfully added to the transaction session, the second device may be disconnected leaving the first and third devices connected to conduct the transaction session.

In some embodiments of the method 200, collaborating in performance of the transaction session includes audio, video, or audio and video communication between two or all of the first, second, and third devices. Data of the audio, video, or audio and video communication is typically transmitted and received via the network, although some embodiments may include peer-to-peer connections directly between participating devices.

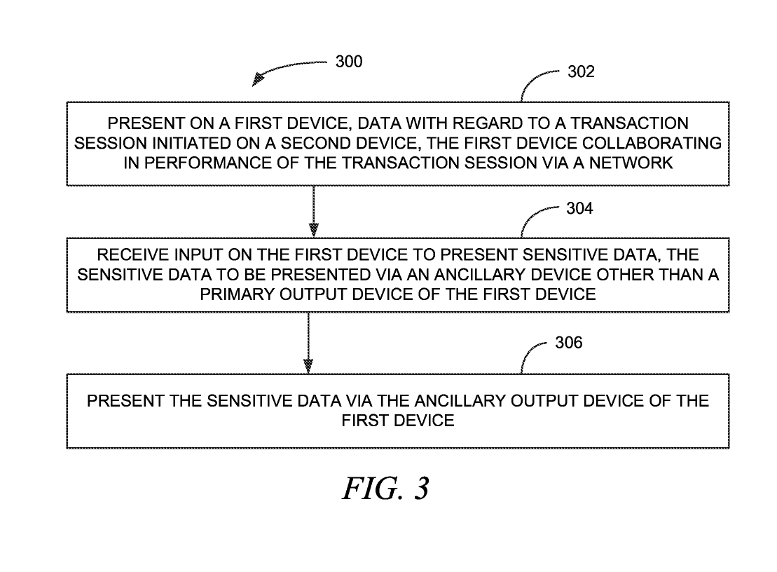

FIG. 3 is a block flow diagram of a method 300 is, according to an example embodiment. The method 300 is an example of a method that is performed on a mobile device of a customer service representative, such as a bank teller, a store clerk, or other customer service representative. The mobile device of the customer service representative may be a tablet, a wearable computing device, and other mobile device-type. Regardless of the mobile device-type, the mobile device includes or is coupled to at least one output device capable of outputting sensitive data to the customer service representative in a manner such that the sensitive data will not be revealed to the customer or others.

The method 300 includes presenting 302, on a first device (e.g., a customer service representative mobile device), data with regard to a transaction session initiated on a second device (e.g., an SST, an ATM, a checkout kiosk, etc.), the first device collaborating in performance of the transaction session via a network. The method 300 further includes receiving 304 input on the first device to present sensitive data, the sensitive data to be presented via an ancillary output device other than a primary output device of the first device. The ancillary output device may be a heads-up display device, an audio headset, or other output device capable of presenting the sensitive data with discretion. The method 300 then presents 306 the sensitive data via the ancillary output device of the first device.

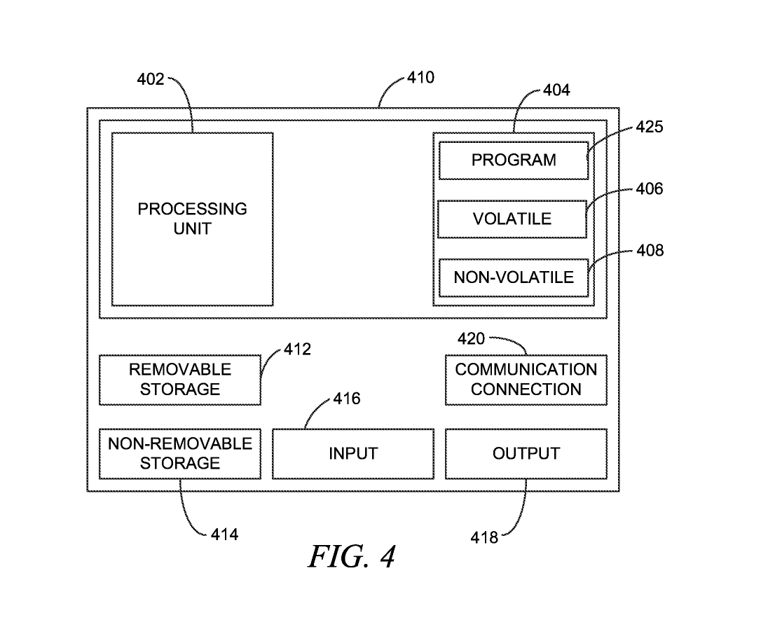

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the various data storage elements are illustrated as part of the computer 410, the storage may also or alternatively include cloud-based storage accessible via a network, such as the Internet.

Although the example computing device is illustrated and described as computer 410, the computing device may be in different forms in different embodiments. For example, the computing device may instead be a smartphone, a tablet, or other computing device including the same or similar elements as illustrated and described with regard to FIG. 4. Some such computing devices, e.g., tablets, smartphones, wearable computing devices, etc., are referred to as mobile devices. The computing device in other embodiments may be a computer deployed with a terminal, such as an SST, such as an ATM, point-of-sale (POS) terminal, customer assistance or informational kiosk, library checkout terminal, and the like. In some such embodiments, the terminal may also include various other devices integrated within or coupled thereto. Such various other devices may include a cash drawer, a bankcard reading device, a signature recording device, a scanner, a receipt printer, a personal identification number (PIN) pad, and a touchscreen display, among others depending upon the type of terminal and the particular embodiment.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes randoaccess memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, PIN pad, camera, microphone, and other input devices. The output may include a primary output, such as a display of a mobile device, and one or more other output devices, such as one or both of a wired or wireless wearable video output device (i.e., a wearable video display device) and audio output device (i.e., headset).

The computer may operate in a networked environment using a communication connection 420 to connect to one or more remote computers, such as database servers, web servers, and other computing devices. An example remote computer may include a personal computer (PC), server, router, network PC, a peer device or other common network node, or the like. The communication connection 420 may be a network interface device such as one or both of an Ethernet device and a wireless card or circuit that may be connected to a network. The communication connection may also or alternatively include a radio frequency data communication transponder device, such as a Bluetooth®-enabled device. The network may include one or more of a Local Area Network (LAN), a Wide Area Network (WAN), the Internet, and other networks.

Computer-readable instructions stored on a computer-readable medium are executable by the processing unit 402 of the computer 410. A hard drive (magnetic disk or solid state), flash memory device, CD-ROM, and RAM are some examples of articles including a non-transitory computer-readable medium. For example, various computer programs 425 or apps, such as one or more applications and modules implementing one or more of the methods or other embodiments illustrated and described herein or an app or application that executes on a mobile device or is accessible via a web browser, may be stored on a non-transitory computer-readable medium.

Another embodiment is in the form of a computing device. The computing device of such embodiments may be a server hosting or facilitating joint transaction sessions with regard to transactions being performed on terminal devices. A joint communication session may be conducted to assist a user of a terminal device.

The computing device of such embodiments includes at least one network interface device, at least one processor, and at least one memory device. The at least one memory device stores instructions executable by the at least one processor to connect a first device and second device in a joint transaction session associated with a transaction initiated on the second device. The second device in some such embodiments is an SST and the first device is a computing device of a customer service representative. The instructions stored on the at least one memory device are further executable within the joint transaction session to receive a request for a third device to join the joint transaction session and to connect the third device to the joint transaction session in response to a received acceptance of an invitation to connect. The third device may be a computing device of another customer service representative that will also provide assistance within the joint communication session. In some embodiments, the third device is a wearable computing device including a display or is coupled, wired or wirelessly, to a wearable display device.

In one such embodiment, the instructions stored on the at least one memory device are further executable by the at least one processor to retrieve data related to the transaction initiated on the second device where the retrieved data includes sensitive data not presentable on the second device according to configuration settings or device capabilities, but is presentable by the third device. The instructions are also executable to transmit the retrieved data to the third device. In one of these embodiments, the instructions are also further executable to receive data from the third device representative of input received on the third device with regard to a transaction activity initiated on the second device, the input related to the sensitive data presentable by the third device. In this embodiment, the instructions are further executable to transmit at least a portion of the data received from the third device to both the first and second devices.

In some of these embodiments, and some other embodiments herein, data related to joint transaction sessions, customer assistance transactions, and the like is recorded and stored on a data storage device. The recorded and stored data provides a record that may be audited, used for training purposes, and for quality assurance. The recorded and stored data may include data representative of a first, second, or third device user that initiated each data processing activity. An example of such a recorded activity is an approval of a banking transaction initiated on the second device where the approval was received from the third device. In some such embodiments, the approval may require consideration of the sensitive data. An identity of the user of the third device may be recorded and stored as well.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting, on a first device, data with regard to a transaction session initiated on a second device, the first device collaborating in performance of the transaction session via a network; and
transmitting a request for a third device to collaboratively join the transaction session in response to command input received by either the first or the second device, the third device capable of presenting sensitive data not allowed for viewing by a user of the second device and not capable of presentation on the first device.

2. The method of claim 1, wherein the third device includes an audio output device, the sensitive data capable of audio output by the audio output device of the third device.

3. The method of claim 1, wherein the transaction session is a banking transaction session and the data with regard to the transaction session includes bank account data and data representative of a banking transaction attempt by a holder of the bank account, the attempted banking transaction needing approval from a user of the third device, the third device including a device app capable of presenting the sensitive data.

4. The method of claim 1, further comprising:
joining the third device in collaborative performance of the transaction session, the joining including the third device gaining access to the data with regard to the transaction session including data representative of actions previously performed during the transaction session and the sensitive data.

5. The method of claim 4, further comprising:
disconnecting the second device from the transaction session upon the third device joining the transaction session.

6. The method of claim 1, wherein the collaborating in performance of the transaction session includes audio or audio and video communication between at least two of the first, second, and third devices, data of the audio or audio and video communication transmitted and received via the network.

7. The method of claim 1, wherein the second device is a customer self-service terminal (SST).

8. The method of claim 7, wherein the SST is an automated teller machine (ATM).

9. The method of claim 7, wherein the third device is a wearable mobile device including a heads-up display.

10. A method comprising:
presenting, on a first device, data with regard to a transaction session initiated on a second device, the first device collaborating in performance of the transaction session via a network;
receiving input on the first device to present sensitive data, the sensitive data to be presented via an ancillary output device other than a primary output device of the first device; and
presenting the sensitive data via the ancillary output device of the first device.

11. The method of claim 10, wherein the ancillary output device is an audio output device of the first device.

12. The method of claim 10, wherein the ancillary output device is a wearable display device capable of communication with the first device.

13. The method of claim 10, wherein the sensitive information is customer-specific data not for view by the customer, the customer being a user of the second device.

14. The method of claim 10, wherein the second device is an automated teller machine (ATM).

15. A computing device comprising:
at least one network interface device, at least one processor, and at least one memory device, the at least one memory device storing instructions executable by the at least one processor to:
connect a first device and second device in a joint transaction session associated with a transaction initiated on the second device;
within the joint transaction session:
receive, from the first device via the at least one network interface device, a request for a third device to join the joint transaction session, the third device being a wearable computing device including a display; and
connect the third device to the joint transaction session in response to a received acceptance of an invitation to connect transmitted via the at least one network interface device.

16. The computing device of claim 15, wherein the instructions stored on the at least one memory device are further executable by the at least one processor to:
retrieve data related to the transaction initiated on the second device, the retrieved data including sensitive data not presentable on the second device but presentable on the third device; and
transmit the retrieved data to the third device.

17. The computing device of claim 16, wherein the instructions stored on the at least one memory device are further executable by the at least one processor to:
receive, via the at least one network interface device, data from the third device representative of input received on the third device with regard to a transaction activity initiated on the second device, the input received related to the sensitive data presentable by the third device; and
transmit, via the at least one network interface device, at least a portion of the data received from the third device to both the first and second devices.

18. The computing device of claim 16, wherein the instructions stored on the at least one memory device are further executable by the at least one processor to:
record, on a data storage device, a record of data processing activities performed within the joint transaction session including data representative of a first, second, or third device user that initiated each data processing activity.

19. The computing device of claim 18, wherein at least one recorded data processing activity is an approval of a banking transaction initiated on the second device, the approval received via the at least one network interface device from the third device, the approval requiring consideration of the sensitive data.

20. The computing device of claim 15, wherein the instructions stored on the at least one memory device are further executable by the at least one processor to:
disconnect the second device from the joint transaction session subsequent to connecting the third device to the joint transaction session.
